(19) United States
(12) Patent Application Publication
(10) Pub. No.: US 2002/0029484 A1
(43) Pub. Date: Mar. 14, 2002

(54) Saw for cutting with pushing movements

(76) Inventor: Kohji Takeuchi, Miki-shi (JP)

Correspondence Address: MOONRAY KOJIMA, BOX 627, WILLIAMSTOWN, MA, 01267, US

(21) Appl. No.: 09/811,313

(22) Filed: Mar. 16, 2001

(30) Foreign Application Priority Data
Sep. 1, 2000 (JP) 2000/265,313

(51) Int. Cl. B27B 33/10

(52) U.S. Cl. 30/517; 30/166.3; 30/340

(57) ABSTRACT

The present invention relates to the saw for cutting with pushing movements (so called western styled saw), adapted to cut vertically (along the grain of wood) or cut horizontally (roughly crossing the grain of wood) against the cutting target material like lumbers, capable of adjusting the angle of the blade body (or the angle of the edge part) freely and regardless of steps according to the needs of the users, wherein the blade body having the edge part is attached to the handle and the attaching hole is formed at the root of the blade body, forming the tightening device on the handle for loosening the root of the blade body and tightening in time of working through the attaching holes, provided with the attaching holes as a long symmetrical hole from up to down, adapted to set the angle of the blade body in respect of the handle freely.

### BACKGROUND OF THE INVENTION

1. Field of the Invention

The present invention relates to the saw for cutting with pushing movements (so called western styled saw), adapted to cut vertically (along the grain of wood) or cut horizontally (roughly crossing the grain of wood) against the cutting target material like lumbers.

2. Description of the Prior Art

As a conventional saw for cutting with pushing movements, there is one, for instance, with a structure shown in the FIG. 26.

In other words, there used to be a saw for cutting with pushing movements, wherein the blade body 92 having the edge part 91 is attached to the handle 93, the root 92c of the blade body 92 comprising two attaching holes 94, 95, together with the handle 93 having the concave groove 96 to install the root 92c of the blade body 92 and with the tightening device 97, 97 consisting of the bolt part and the nut part, loosening and in time of working, tightening the root 92c of the blade body 92 installed in the above said groove 96, thus providing for the blade body 92 to be oriented according to the first position α of one example of vertical cutting shown in the FIG. 26 with the solid line and the second position β of another example of horizontal cutting shown with the virtual line.

According to this prior art, there is no need to shift between the blade body for vertical cutting and the blade body for horizontal cutting and only by changing the angle of one blade body 92 toward the handle 93, it is possible to select a vertical cutting or a horizontal cutting, however, as the blade body 92 is installed only on two positions of α, β, as shown in the FIG. 26, there is a problem that the angle of the blade body 92 could not be adjusted freely and regardless of steps, according to the needs of the users.

### SUMMARY OF THE INVENTION

The main purpose of the present invention is to provide a saw for cutting with pushing movements capable of adjusting the angle of the blade body (or the angle of the edge part), freely and regardless of steps, according to the needs of the users, by comprising the attaching holes formed at the root of the blade body (including both consecutive holes as one and a pair of the holes not consecutive) as a long symmetrical hole from up to down.

Another purpose of the present invention is to provide a saw for cutting with pushing movements, wherein, when it is large, the blade body is strongly fixed on a plurality of spots including three spots, by providing for a long hole to serve as an attaching hole which is one consecutive long hole from up to down, making the process of the attaching hole easy, while spots to be tightened by the tightening device may be two or more.

Furthermore, another purpose of the present invention is to provide a saw for cutting with pushing movements, capable of forming a pair of attaching holes, above and below, without lowering rigidity of the root of the blade body by providing an attaching long hole in a pair of attaching holes, above and below, which are not consecutive.

Furthermore, another purpose of the present invention is to provide a saw for cutting with pushing movements, capable of attaching and removing the blade body from the determined position by utilizing the hole for attaching and removing the same without having to remove the tightening device from the handle, by forming the attaching and removing hole, connecting a pair of attaching holes, above and below, with the end of the blade body.

In addition, another purpose of the present invention is to provide a saw for cutting with pushing movements, capable of setting the angle of the blade body freely and regardless of any steps, depending on the types of target lumbers or the needs of the users, or any example of vertical cutting and horizontal cutting, irrespective of using the edge part for vertical cutting or the edge part for horizontal cutting, by forming the edge part for vertical cutting on one part of the blade body and also the edge part for horizontal cutting on the other part.

Other purposes of the present invention will be easily clarified according to the below examples.

### BRIEF DESCRIPTION OF THE DRAWING

FIG. 1 is an outside view of the saw for cutting with pushing movements according to the present invention.

FIG. 2 is a section view drawn with the arrow line D-D according to the FIG. 1.

FIG. 3 is an explanatory view of the standing position.

FIG. 4 is an explanatory view of one example of vertical cutting.

FIG. 5 is an explanatory view of one example of horizontal cutting.

FIG. 6 is an explanatory view of another example of the saw for cutting with pushing movements.

FIG. 7 is an explanatory view of one example of vertical cutting.

FIG. 8 is an explanatory view of one example of horizontal cutting.

FIG. 9 is an explanatory view of another more example of the saw for cutting with pushing movements.

FIG. 10 is an explanatory view of one example of vertical cutting.

FIG. 11 is an explanatory view of one example of horizontal cutting.

FIG. 12 is an explanatory view of another more example of the saw for cutting with pushing movements.

FIG. 13 is an explanatory view of one example of vertical cutting.

FIG. 14 is an explanatory view of one example of horizontal cutting.

FIG. 15 is an explanatory view of another more example of the saw for cutting with pushing movements.

FIG. 16 is an explanatory view of one example of vertical cutting.

FIG. 17 is an explanatory view of one example of horizontal cutting.

FIG. 18 is an explanatory view of the blade body being attached.

FIG. 19 is an explanatory view of another more example of the saw for cutting with pushing movements.

FIG. 20 is an explanatory view of one example of vertical cutting.

FIG. 21 is an explanatory view of one example of horizontal cutting.

FIG. 22 is an explanatory view of another more example of the saw for cutting with pushing movements.

FIG. 23 is an explanatory view of one example of vertical cutting.

FIG. 24 is an explanatory view of one example of horizontal cutting.

FIG. 25 is an explanatory view of the blade body being attached.

FIG. 26 a section view of the conventional saw for cutting with pushing movements.

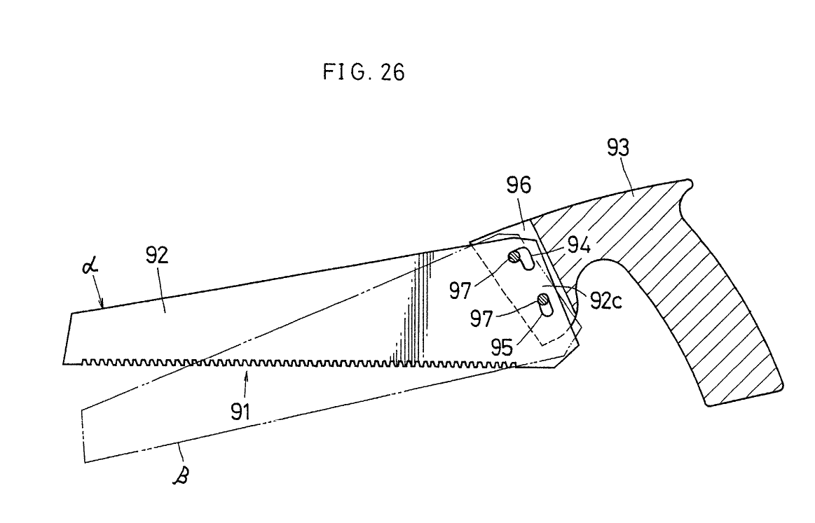

### DESCRIPTION OF THE PREFERRED EMBODIMENT

One preferred embodiment of the present invention will be more particularly described below, using the following figures.

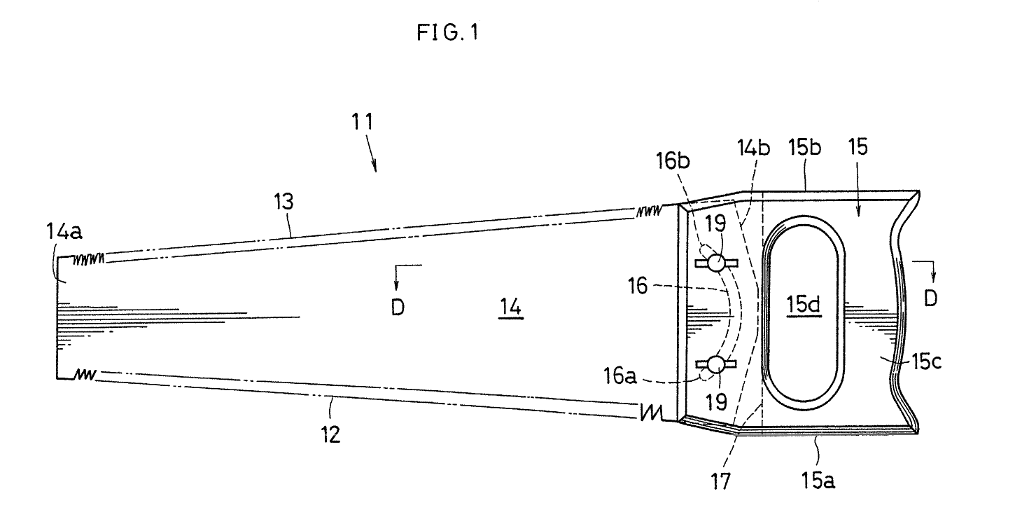

The figures show the saw for cutting with pushing movements (so called a western styles saw) and according to the FIGS. 1 to 3, this saw 11 for cutting with pushing movements is provided with the blade body 14 having edge parts 12, 13, which blade body is attached to the handle 15 (so called “grip”).

One of the blade bodies 12, 13, specifically 12 is provided for the vertical cutting purpose, and another blade body 13 is provided for the horizontal cutting, thus composing the blade body 14 made of double edges and it is needless to say that this blade body 14 may be a one-edge structure, having either purpose of the vertical cutting or horizontal cutting.

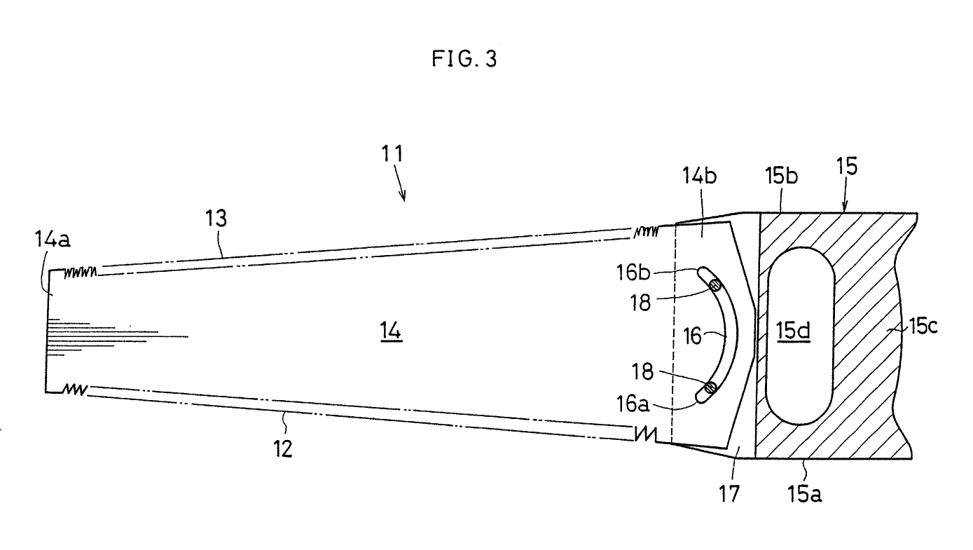

The blade body 14 is provided with the head (toe) 14a and the root (heel) 14b, wherein the attaching hole 16 is formed in the long symmetrical hole from up to down at the root 14b of the blade body so that the angle of the blade body 14 can be set freely and regardless of steps against the handle 15 as shown in the FIG. 3.

According to this example, the attaching hole 16 has both ends 16a and 16b and may be one attaching hole 16 in the shape of consecutive circular arcs from up to down.

On the other hand, on the handle 15 there is provided the concave groove 17 (the space for changing the angle of the blade body 14 without steps) installed to the root 14b of the blade body 14 on its center tip, and two pairs of tightening devices 18, 18 (a plurality of tightening devices) for tightening the root 14b of the blade body 14 in time of working and loosening through the attaching hole 16 are provided on the position corresponding to the concave groove 17 at a distance. When the said distance is small, the angle of the blade body 14 may become larger.

According to this example, the blade body 14 of a double edge structure is being used, wherein the handle 15 is symmetrical from up to down, however, when the blade body of a single edge structure is used, the handle 15 does not have to be symmetrical from up to down.

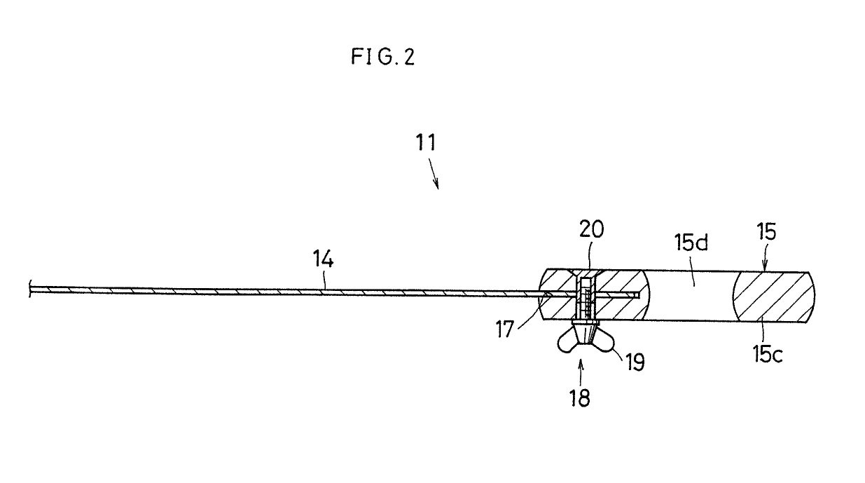

The tightening device 18 is formed of a bolt device 19 in the shape of a butterfly as shown in the FIG. 2 and the nut device 20 in the shape of a dish bolt, wherein a hole in the shape of a cross (+) or minus (−) to insert the tip of the instruments like a driver is formed on the head surface of the nut device 20. It is noted that the above mentioned bolt device 19 in the shape of a butterfly bolt is not limited to the above example, and the bolt device 19 in the shape of a dish bolt as well as the nut device 20 may be used. In addition, in the FIGS. 3, 4, 5 and each of the below examples, the sectional structure of the tightening device 18 is briefly shown for the purpose of illustration.

In addition, the handle 15 has one side 15a, the other side 15b, the end part 15c and the space part 15d into which the finger of the user can be inserted, comprising materials like lumber and the handle 15 may be made of other materials like plastic.

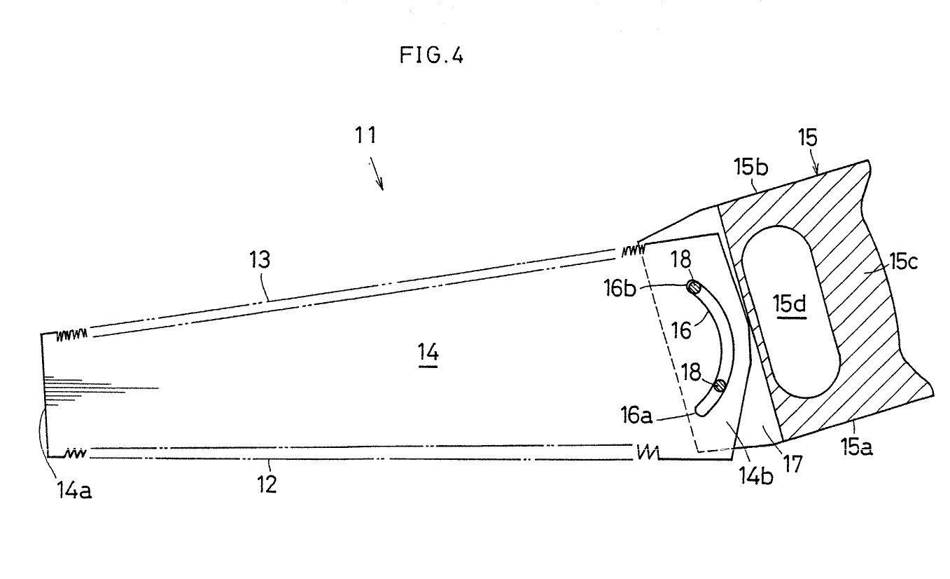

When the saw 11 for cutting with pushing movements with the above said structure is used for vertical cutting, upon loosening the tightening device 18, the location of the blade body 14 will be accordingly changed along the attaching hole 16 (in the direction the tightening device 18 is approaching the end part 16b) from the suspending position as shown in the FIG. 3 toward the handle 15 as shown in the FIG. 4, wherein the angle of the blade body 14 is adjusted regardless of steps, according to the needs of the user and when the tightening device 18 is tightened in an arbitrary location within a range of formation of the attaching hole 16, the saw will be set for vertical cutting as shown in the FIG. 4.

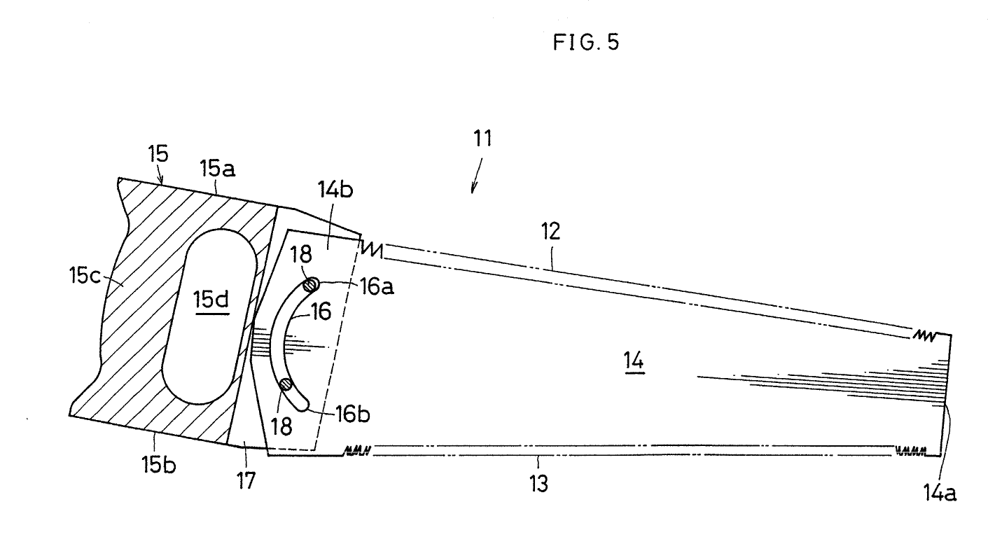

When the saw 11 for cutting with pushing movements is used for horizontal cutting, upon loosening the tightening device 18, the location of the blade body 14 will be accordingly changed along the attaching hole 16 (in the direction the tightening device 18 is approaching the end part 16a) from the suspending position as shown in the FIG. 3 toward the handle 15 as shown in the FIG. 5, wherein the angle of the blade body 14 is adjusted regardless of steps, according to the needs of the user and when the tightening device 18 is tightened in an arbitrary location within a range of formation of the attaching hole 16, the saw will be set for horizontal cutting as shown in the FIG. 5.

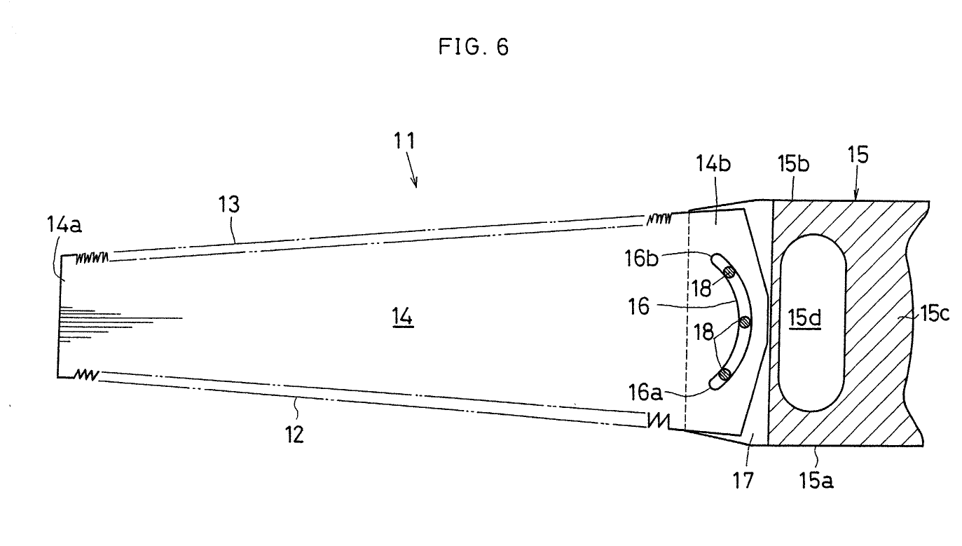

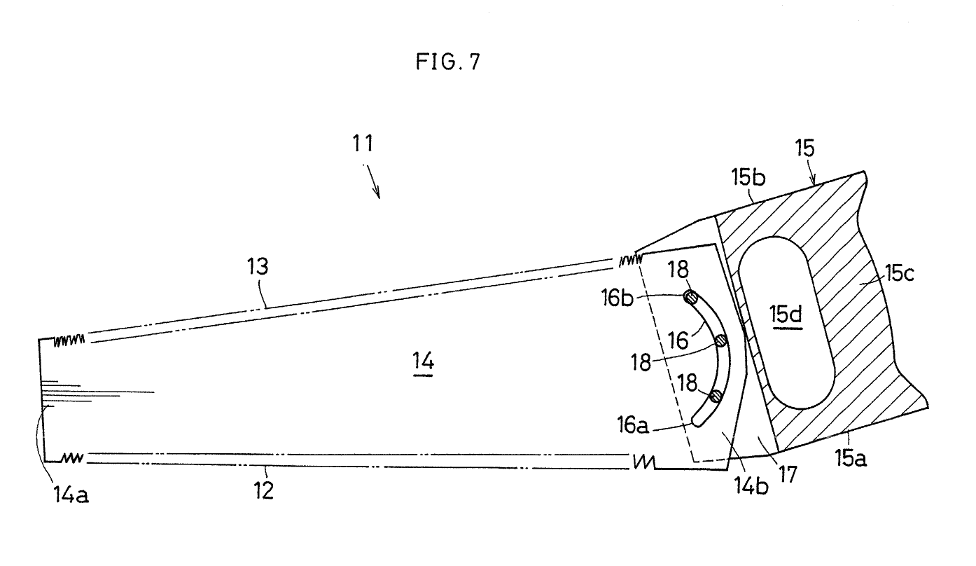

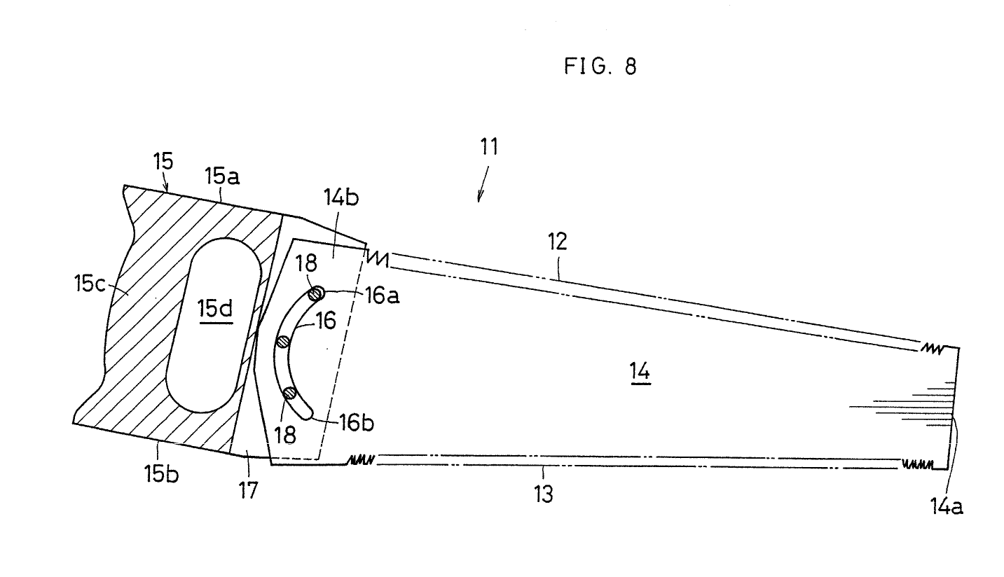

Furthermore, when the attaching hole 16 is designed to be one attaching hole in the shape of a circular arc which is consecutive from up to down, the tightening spots of the tightening device 18 as shown in the FIGS. 6, 7 and 8 may be three or more, thus becoming effective when the large saw for cutting with pushing movements is composed. In addition, the FIG. 8 shows the suspending position, while the FIG. 7 shows one example of vertical cutting and the FIG. 8 shows one example of horizontal cutting.

The saw for cutting with pushing movements as shown in the examples of the FIGS. 1 to 8 is the saw 11 for cutting with pushing movements with the blade body 14 having edge parts 12 and 13, attached to the handle 15, wherein the attaching hole 16 is formed at the root 14b of the blade 14 and the tightening device 18 for tightening the root 14b of the blade body 14 in time of working through the attaching hole 16 and loosening at the handle 15, while the attaching hole 16 is formed as a long symmetrical hole from up to down so that the angle of the blade body 14 is freely set against the handle 15.

According to the above construction, the tightening device 18 is loosened and the location of the blade 14 against the handle 15 is accordingly changed along the attaching hole 16, the angle of the blade body 14 can be freely set, regardless of steps according to the needs of the users (like types of the target lumber to be cut).

When the blade body 14 is set in the middle position (see the FIG. 3 and FIG. 6) in respect of the handle 15, the whole body will be symmetrical (from up to down), thus allowing for making smaller the dimension for package, transportation or a containing process.

In addition, as the attaching hole 16 in the shape of a long hole is designed to be one attaching hole 16 which is consecutive from up to down, it will make the process of the attaching hole 16 easy and the tightening spots of the tightening device 18 will be two (see the FIGS. 1 to 5) and more (FIGS. 6 to 8) and in case of composing the larger type of the saw for cutting with pushing movements, the blade body 14 will be firmly fixed in a plurality of spots including three spots.

Furthermore, the edge part 12 for vertical cutting is formed on one side of the above said blade body 14 and on the other side there is formed the edge part 13 for horizontal cutting together with the blade body 14 and in either case of the edge part 12 for vertical cutting being used or the edge part 13 for horizontal cutting being used, the angle of the blade body 14 will be set freely and regardless of steps according to the needs of the users or depending on the vertical cutting or horizontal cutting or the types of the cutting target lumber.

In other words, the angle of the saw for cutting with pushing movements in time of vertical cutting may as well be shallower than in time of horizontal cutting and the angle of the blade body 14 can be freely adjusted according to each of the vertical cutting or the horizontal cutting or the needs of the users or the types of the lumbers to be cut.

In addition, the attaching hole 16 may be a symmetrical hole from right to left with respect to the form shown in the figures, thus obtaining the same effects. This is true with each of the examples, which are set forth below. Furthermore, when the attaching hole 16 is adapted to be a circular arc, this attaching hole 16 can be divided into two or three or even more.

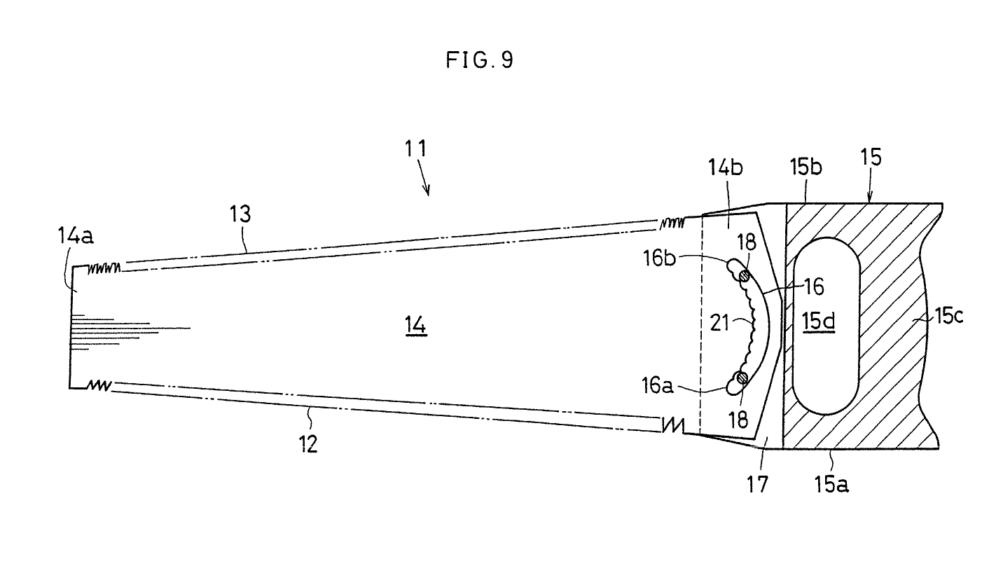

The FIGS. 9, 10 and 11 show other examples of the saw for cutting with pushing movements, wherein, in addition to the foregoing examples of the attaching hole 16 showing its structure, a plurality of notches 21 are formed on the hole edge on one side, for instance, the head 14a of the attaching hole 16.

According to the above structure, by retaining both of the notch 21 and the tightening device 18, the conductivity involving the pressure against the blade body 14 can be elevated. Furthermore, the notch 21 can be formed not only on the head 14a but also on the hole edge of the root 14b respectively.

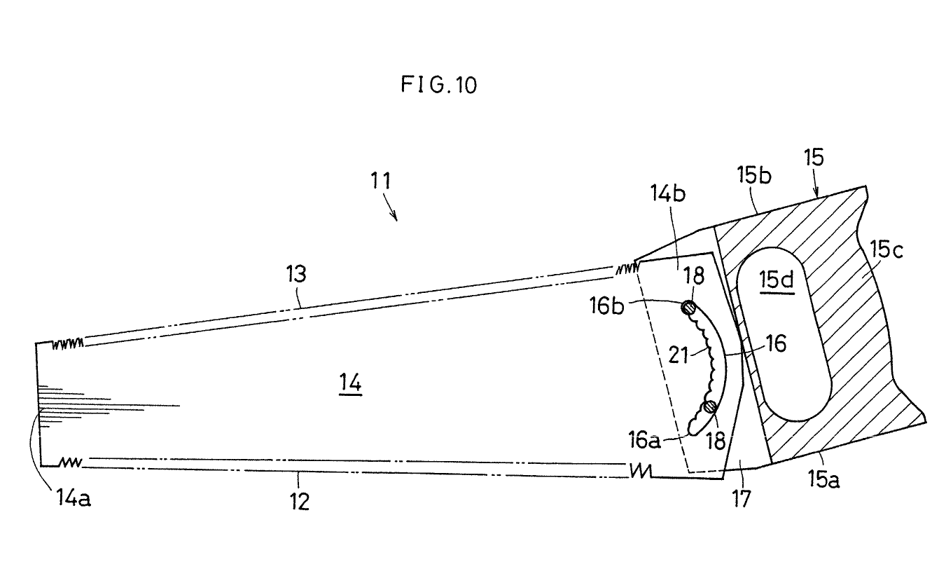

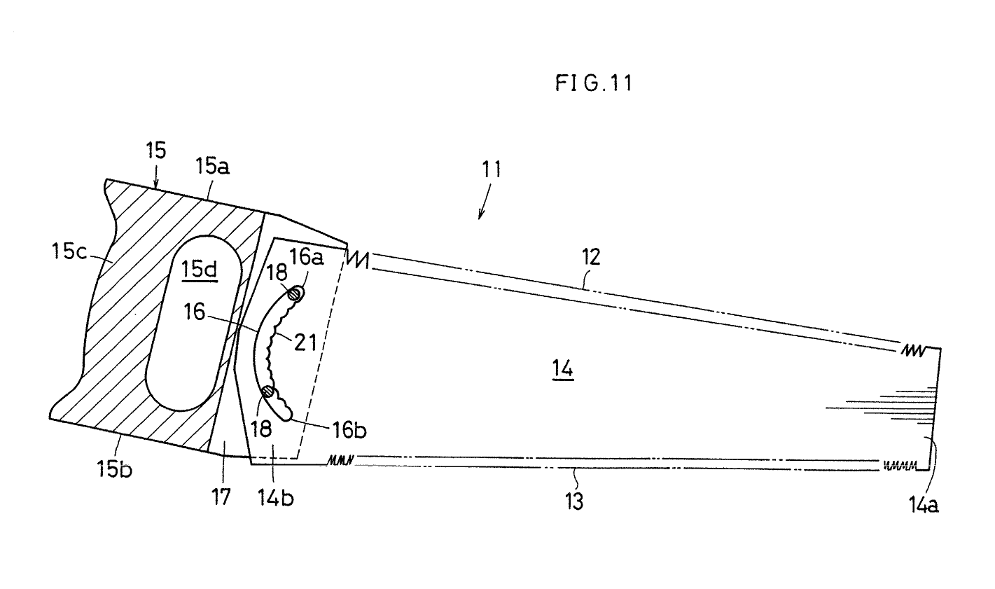

According to this example, also, other structures, operations and effects are the same as in the foregoing examples so that the same signs are put for the same parts as in the previous figures regarding the FIGS. 9 to 11 and more particular details will be omitted, however, the FIG. 9 shows the suspending position and the FIG. 10 shows the example of vertical cutting and the FIG. 11 shows the example of horizontal cutting, respectively.

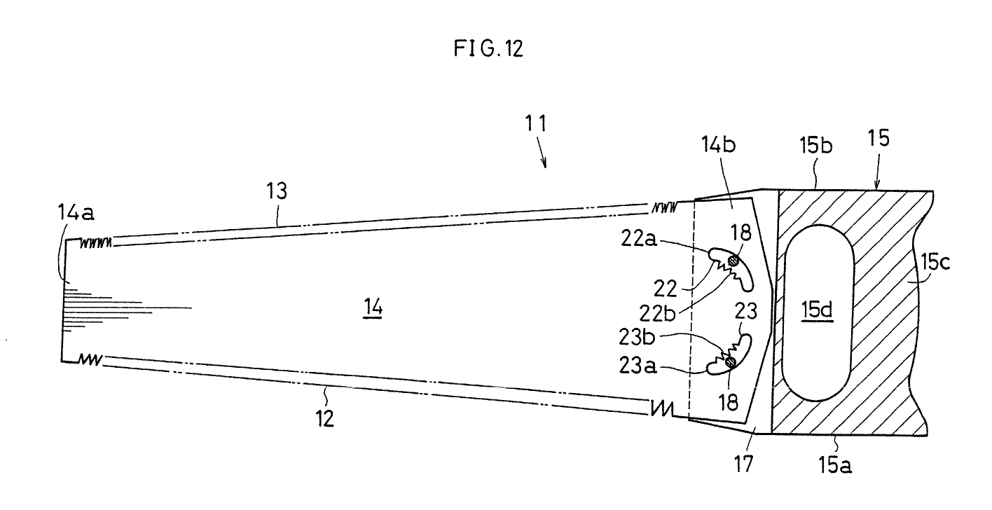

The FIGS. 12, 13 and 14 show another more example of the saw for cutting with pushing movements, wherein, instead of one attaching hole 16, which is consecutive from up to down according to the above mentioned each example, there are formed at the root 14b of the blade body 14, a pair of the attaching holes 22, 23, above and below, which are not consecutive, forming a symmetrical circular arc from up to down, out of these attaching holes 22, 23, together with the concave and convex parts 22b, 23b (resistance adding elements), which are indented, preventing the difference of location of the blade body 14 by the friction resistance added to part of the attaching holes 23, 23.

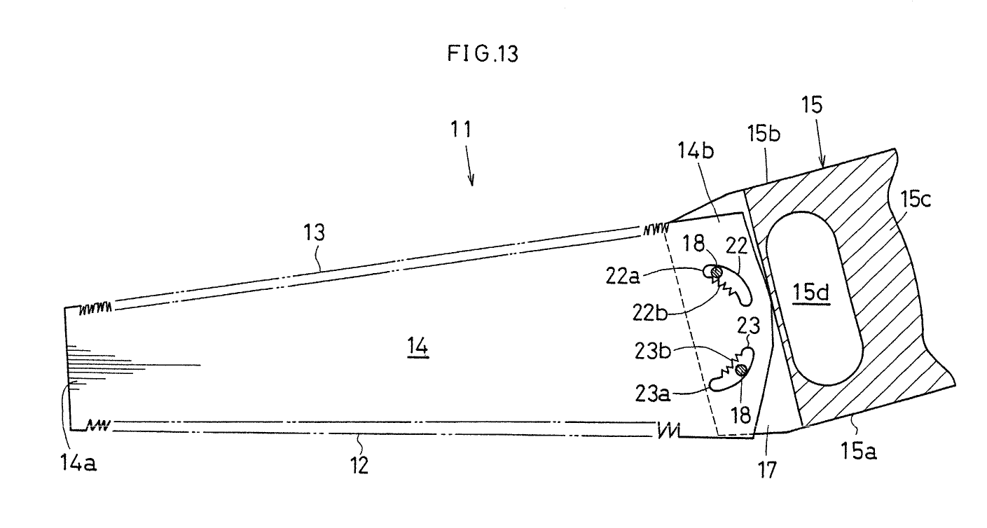

When the saw 11 for cutting with pushing movements as above constructed is used for vertical cutting, upon loosening the tightening device 18, the location of the blade body 14 against the handle 15 as shown in the FIG. 13 will be accordingly changed along the attaching holes 22, 23 (in the direction the tightening device 18 is approaching the end part 22b) from the suspending position shown in the FIG. 12, wherein the angle of the blade body 14 is adjusted according to the needs of the users and regardless of steps and when the tightening device 18 is tightened in an arbitrary location within a range of the formation of the attaching holes 22, 23, the vertical cutting is provided as shown in the FIG. 13.

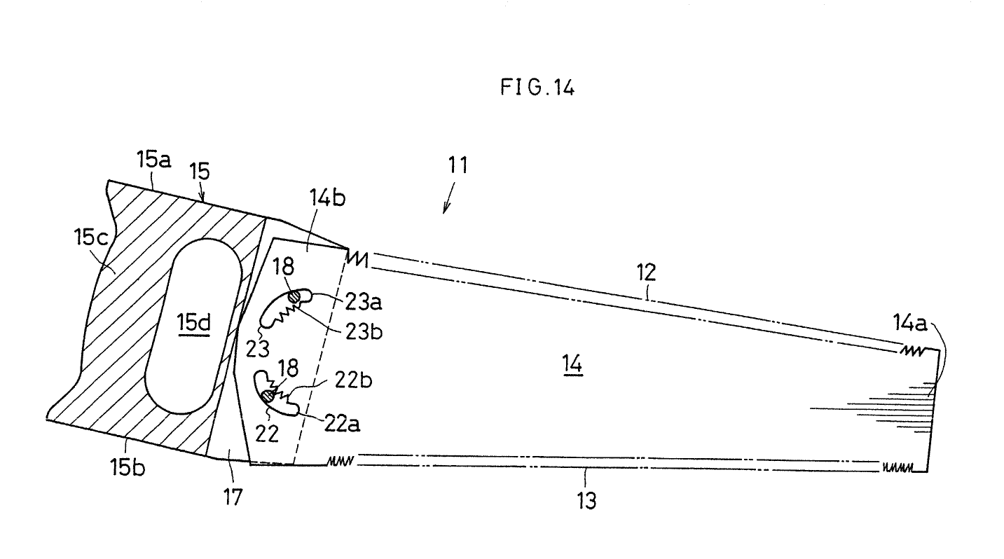

In addition, when the saw 11 for cutting with pushing movements is used for horizontal cutting, upon loosening the tightening device 18, the location of the blade body 14 against the handle 15 as shown in the FIG. 14 will be accordingly changed along the attaching holes 22, 23 (in the direction the tightening device 18 is approaching the end part 23a) from the suspending position shown in the FIG. 12, wherein the angle of the blade body 14 is adjusted according to the needs of the users and regardless of steps and when the tightening device 18 is tightened in an arbitrary location within a range of the formation of the attaching holes 22, 23, the horizontal cutting is provided as shown in the FIG. 14.

Thus, the saw 11 for cutting with pushing movements, as shown in the FIGS. 12 to 14 is provided with the attaching hole in the shape of the long hole, which is made in a pair of the attaching holes 22, 23, which are not consecutive from up to down so that the rigidity of the root 14b of the blade body 14 will not be lowered when forming a pair of the attaching holes 22, 23, above and below.

In addition, in this example, other structures, operations and effects are the same as in the previous examples so that the same signs are put for the same parts in the FIGS. 12 to 14 as in the previous figures and more particular explanation will be omitted.

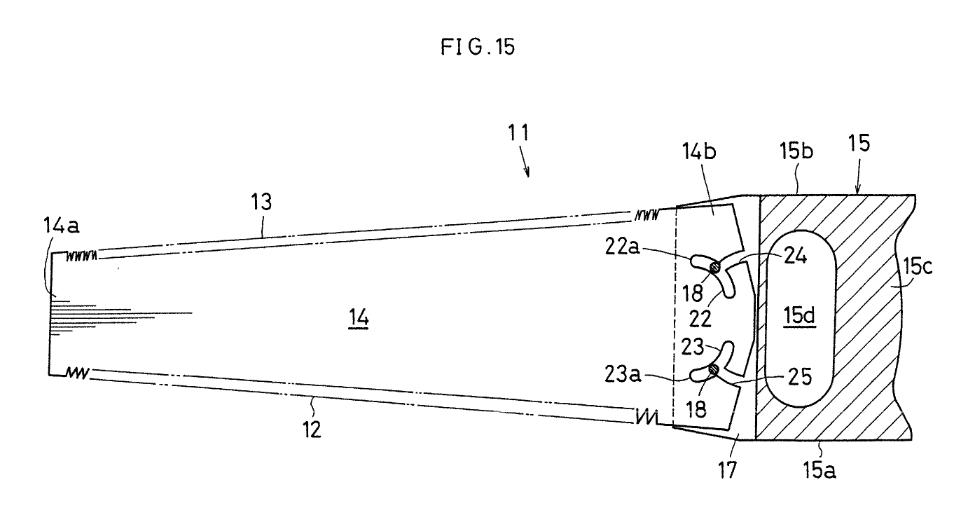

In the FIGS. 15, 16, 17 and 18 there are shown more examples of the saw for cutting with pushing movements, wherein the attaching and removing holes 24, 15 connecting a pair of the attaching holes 22, 23, above and below with the end part on the side of the root 14b of the blade body 14 are formed, adding to the structure of the above mentioned FIGS. 12 to 14.

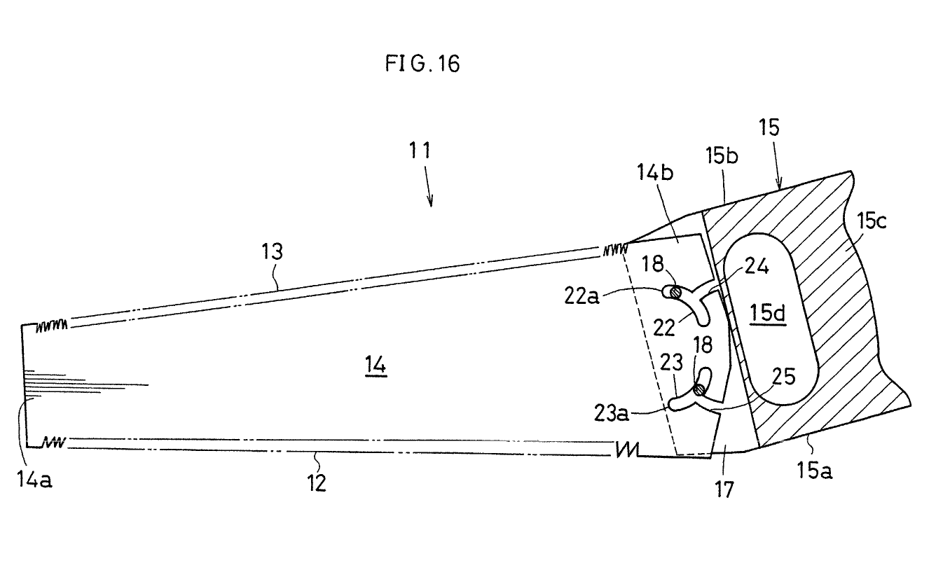

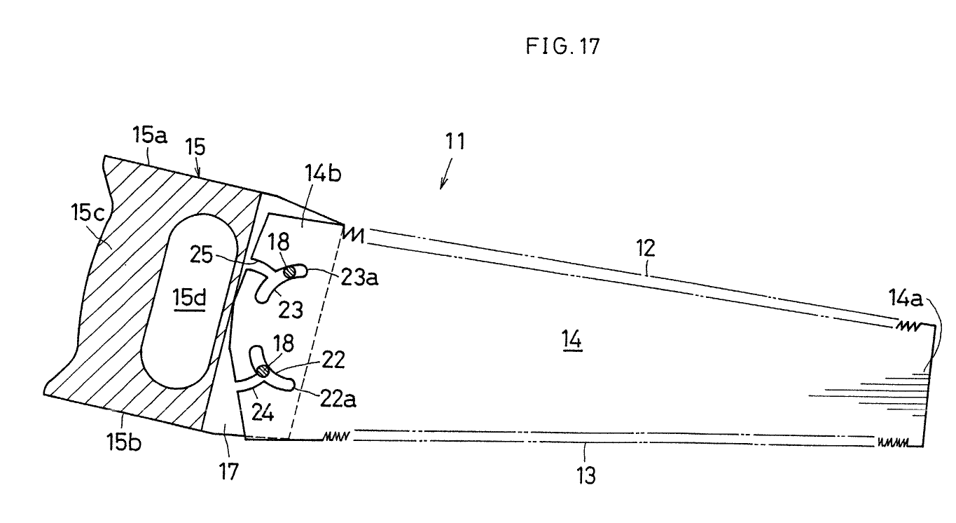

The attaching and removing holes 24, 25 are formed as a circular arc, such as one extending a little outwards from the connecting part with the attaching holes 22, 23, and when there is formed an example of vertical cutting as shown in the FIG. 16 or in the case that there is formed an example of horizontal cutting as shown in the FIG. 17 also, the attaching devices 18, 18 are supported at the hole edge of the root 14b of each of the attaching holes 22, 23.

In this way, by forming the attaching and removing holes 24, 25 connecting a pair of the attaching holes 22, 23, above and below and the end part of the blade body 14, the blade body 14 can be attached and removed in a determined position by making use of the attaching and removing holes 24, 25 without having to remove the tightening device 18 from the handle 15.

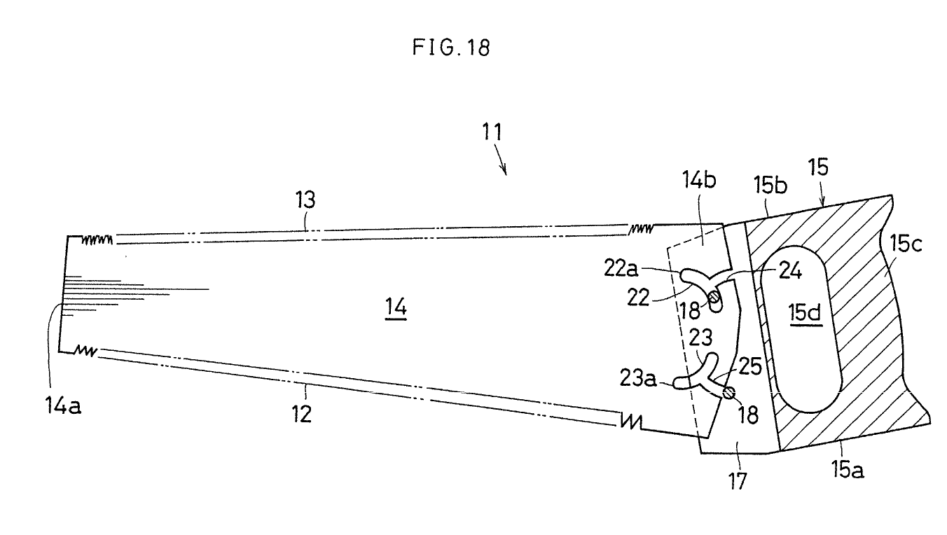

For instance, as shown in the FIG. 18, after the blade body 14 is moved so that one tightening device 18 is located from one attaching and removing hole 24 into the attaching hole 22, another tightening device 18 is located from the attaching and removing hole 25 into the attaching hole 23 while changing the position of the said blade body 14, the blade body 14 can be attached to the determined position as shown in the FIG. 15.

Being constructed as above, other structures, operations, effects are the same as in the FIGS. 12 to 14 so that the same signs are put for the same parts in the FIGS. 15 to 18 as in the previous figures and more particular explanations will be omitted.

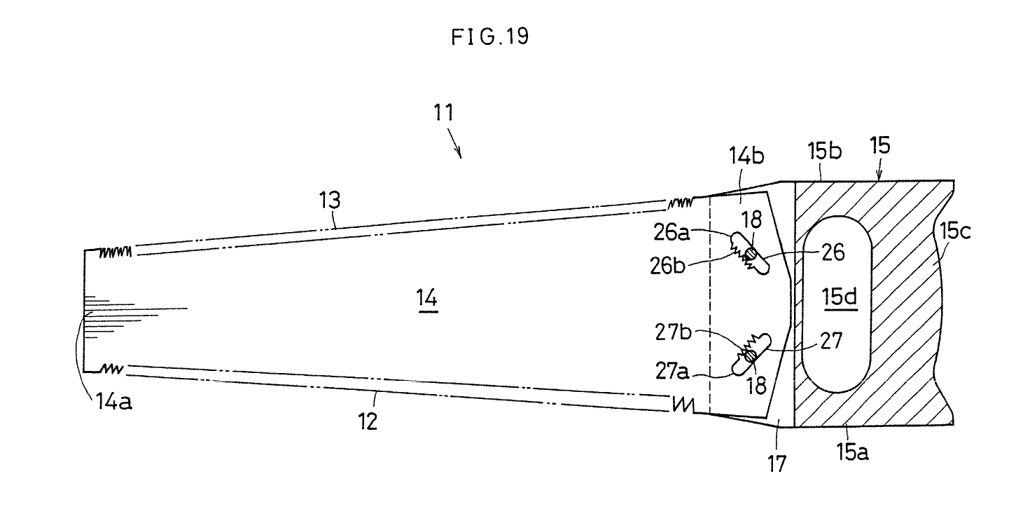

The FIGS. 19, 20 and 21 show furthermore examples of the saw for cutting with pushing movements, wherein, instead of a pair of the attaching holes 22, 23, above and below, in the shape of a circular arc, a pair of the symmetrical attaching holes 26, 27 from up to down, which are formed of the straight line, inclined with a determined angle, are formed, and in addition to that, the concave and convex parts 26b, 27b, (resistance adding elements), which are indented, are provided on part of the attaching holes 26, 27, in order to prevent differences of location concerning the blade body 14 with a friction resistance.

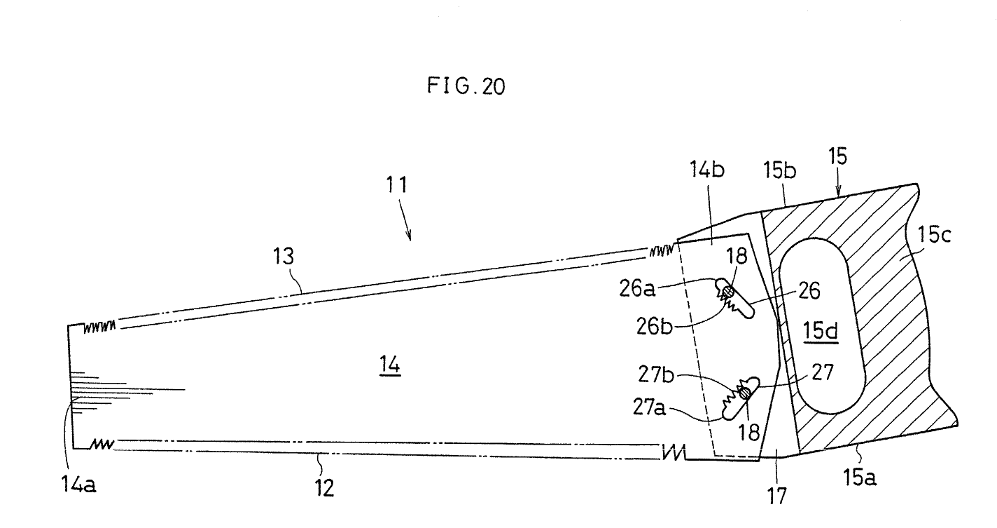

When the saw 11 for cutting with pushing movements as above constructed, is used for vertical cutting, upon loosening the tightening device 18, the location of the blade body 14 against the handle 15 as shown in the FIG. 20 will be accordingly changed along the attaching holes 26, 27 (in the direction the tightening device 18 is approaching the end part 26b) from the suspending position as shown in the FIG. 19, wherein the angle of the blade body 14 is adjusted according to the needs of the users and regardless of the steps and when the tightening device 18 is tightened in an arbitrary location within a range of the formation of the attaching holes 26, 27, the vertical cutting is provided as shown in the FIG. 20.

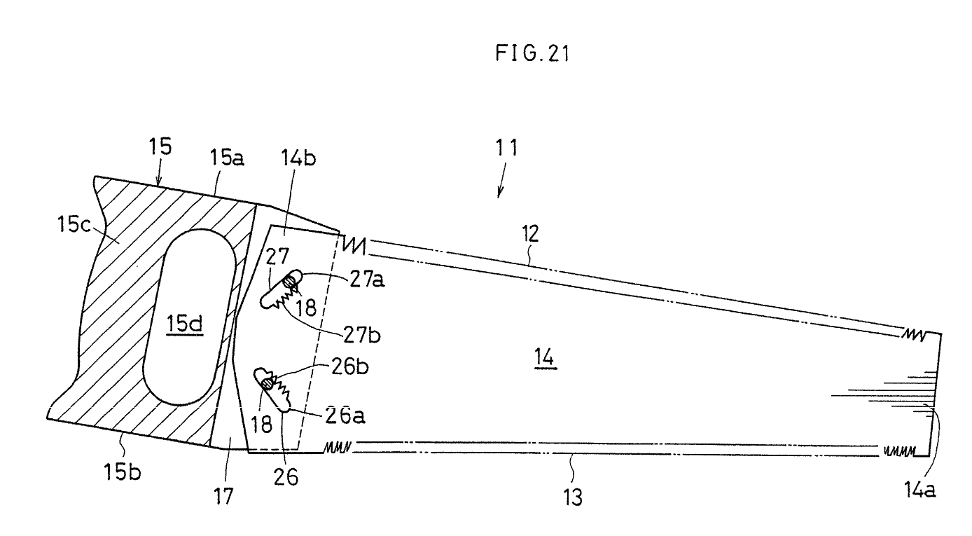

When the saw 11 for cutting with pushing movements, is used for horizontal cutting, upon loosening the tightening device 18, the location of the blade body 14 against the handle 15 as shown in the FIG. 21 will be accordingly changed along the attaching holes 26, 27 (in the direction the tightening device 18 is approaching the end part 27a) from the suspending position as shown in the FIG. 19, wherein the angle of the blade body 14 is adjusted according to the needs of the users and regardless of steps and when the tightening device 18 is tightened in an arbitrary location within a range of the formation of the attaching holes 26, 27, the horizontal cutting is provided as shown in the FIG. 21.

Even being constructed as above, other structures, operations and effects are the same as in the examples of the FIGS. 12 to 14 so that the same signs are put for the same parts in the FIGS. 19 to 21 as in the previous figures, thus omitting the explanations in detail. On the other hand, the attaching holes 26, 27 may be formed consecutively, thus providing one symmetrical attaching hole from up to down.

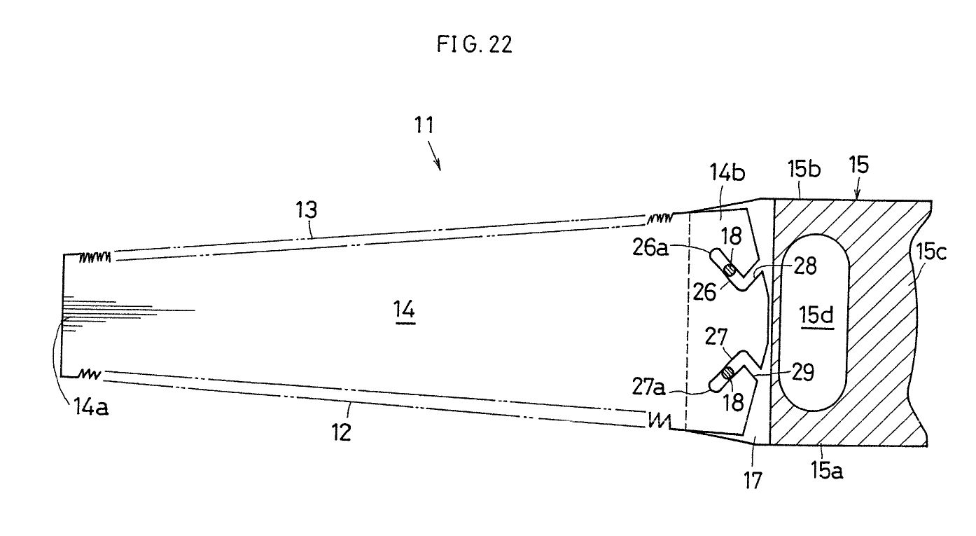

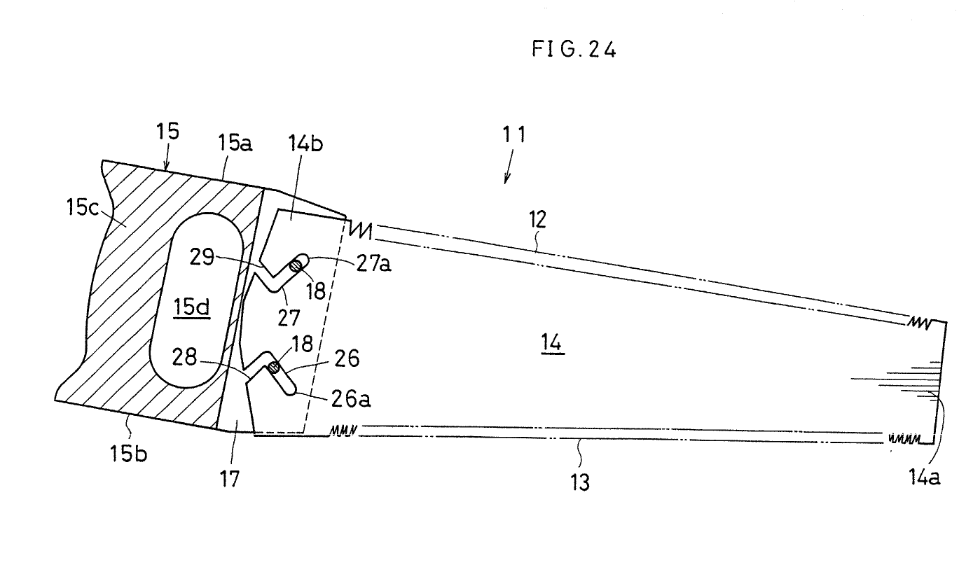

The FIGS. 22 to 25 show more examples of the saw for cutting with pushing movements, wherein, in addition to the structures shown in the FIGS. 19 to 21, there are formed the attaching and removing holes 28, 29 connecting a pair of the attaching holes 26, 27, above and below, with the end part on the side of the root 14b of the blade body 14.

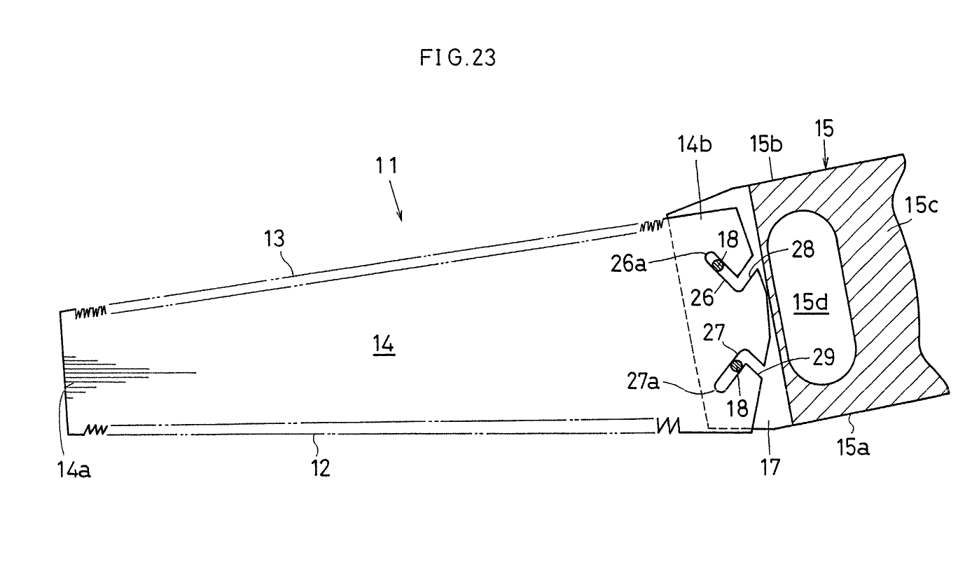

It is noted that the attaching and removing hole 28 is roughly in parallel with the attaching hole 27, extending from the below end of the attaching hole 26 upwards, wherein the other attaching hole 29 is roughly in parallel with the attaching hole 26, extending from the above end of the downwards and when the vertical cutting as in the FIG. 23 is formed and also in the case of the horizontal case as shown in the case 24, the attaching devices 18, 18 are supported at the hole edge of the root 14b of each of the attaching holes 26, 27.

In this way, when the attaching and removing holes 28, 29 are formed as connecting a pair of the attaching holes 26, 27, above and below, with the end part of the blade body 14, the blade body 14 can be attached and removed in a determined position by making use of the attaching and removing holes 28, 29 without having to remove the tightening device 18 from the handle 15.

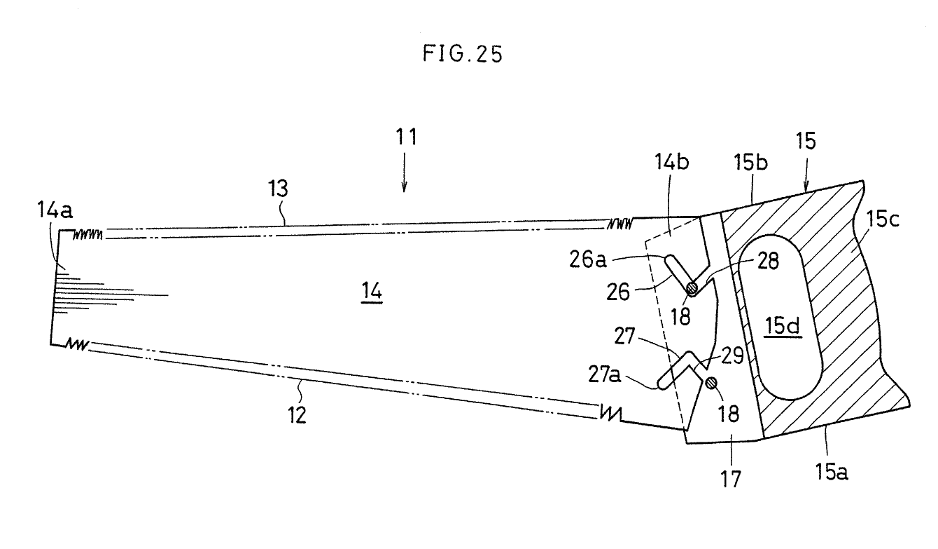

As shown in the FIG. 25, after the blade body 14 is moved so that one side of the tightening device 18 is located from one attaching and removing hole 28 into the attaching hole 26, and when, by changing the position of the blade body 14, the other tightening device 18 is located from the attaching and removing hole 29 into the attaching hole 27, the blade body 14 can be attached in a determined position as shown in the FIG. 22.

Even being constructed like this, other structures, operations and effects are the same as in the FIGS. 19 to 21 so that the same signs are put for the same parts in the FIGS. 22 to 25 as in the previous figures and more detailed explanations will be omitted.

According to the structures of the present invention and the above corresponding examples, the saw for cutting with pushing movements corresponds to the saw 11 for cutting with pushing movements with a double edge structure as in the preferred embodiment, however, the scope of the present invention will not be limited to the structure of the above examples and the saw for cutting with pushing movements may be formed as a single edge structure for either of the vertical cutting or horizontal cutting.

Even when the symmetrical attaching hole is formed from right to left, in respect of the attaching hole shown in the examples of the figures, roughly the same operations and effects can be expected.

To summarize the above, according to the present invention, by comprising the attaching holes formed at the root of the blade body (including both consecutive hole as one and a pair of the holes not consecutive) as a long symmetrical hole from up to down, the angle of the blade body (or angle of the edge part) can be adjusted freely and regardless of steps, according to the needs of the users.

1. The saw for cutting with pushing movements, provided with the blade body having the edge part, attached to the handle, wherein attaching holes are formed at the root of the blade body, together with the tightening device for loosening the root of the blade body and in time of working, tightening through the attaching holes on the handle and the attaching holes are made in the symmetrical long hole from up to down, allowing for setting the angle of the blade against the handle freely.

2. The saw for cutting with pushing movements according to claim 1, wherein the attaching holes in the form of the long hole are a set of consecutive attaching holes, above and down.

3. The saw for cutting with pushing movements according to claim 1, wherein the attaching holes in the form of the long hole are a pair of attaching holes not consecutive, above and below.

4. The saw for cutting with pushing movements according to claim 3, wherein attaching and removing holes connecting the end of the blade body with a pair of the attaching hole, above and below, are formed.

5. The saw for cutting with pushing movements according to claim 1, wherein the edge part for vertical cutting is formed on one side of the blade body, and the edge part for horizontal cutting is formed on the other side of the same.
